(19) United States
(12) Patent Application Publication
(10) Pub. No.: US 2024/0162482 A1
(43) Pub. Date: May 16, 2024

(54) POSITIVE ELECTRODE MATERIAL, SOLID-STATE BATTERY, METHOD OF MANUFACTURING POSITIVE ELECTRODE MATERIAL, AND METHOD OF MANUFACTURING SOLID-STATE BATTERY

(71) Applicants: TOYOTA JIDOSHA KABUSHIKI KAISHA, Toyota-shi (JP); Panasonic Holdings Corporation, Osaka (JP)

(72) Inventors: Masahiro IWASAKI, Toyota-shi (JP); Masaki HIRASE, Kobe-shi (JP); Hiroki YABE, Hirakata-shi (JP); Yusuke ITO, Kashihara-shi (JP)

(73) Assignees: TOYOTA JIDOSHA KABUSHIKI KAISHA, Toyota-shi (JP); Panasonic Holdings Corporation, Osaka (JP)

(21) Appl. No.: 18/383,961

(22) Filed: Oct. 26, 2023

(30) Foreign Application Priority Data
Nov. 15, 2022 (JP) 2022-182925

(51) Int. Cl. H01M 10/0562; H01M 4/136; H01M 4/1397

(52) U.S. Cl. CPC H01M 10/0562; H01M 4/136; H01M 4/1397; H01M 2004/028

(57) ABSTRACT

There is provided a positive electrode material that can be used to manufacture a solid-state battery whose initial resistance is kept low and at which it is difficult for resistance to increase even if charging/discharging are repeated. The positive electrode material of the present disclosure contains a positive electrode active material complex and a sulfide solid electrolyte. The positive electrode active material complex contains: a positive electrode active material, a conductive additive covering at least a portion of a surface of the positive electrode active material, and a solid electrolyte covering at least a portion of the conductive additive. The solid electrolyte contains Li, Ti, X and F. The X is at least one selected from the group consisting of Ca, Mg, Al, Y and Zr.

### CROSS-REFERENCE TO RELATED APPLICATION

This application is based on and claims priority under 35 USC 119 from Japanese Patent Application No. 2022-182925 filed on Nov. 15, 2022, the disclosure of which is incorporated by reference herein.

### BACKGROUND

### Technical Field

The present disclosure relates to a positive electrode material, a solid-state battery, a method of manufacturing a positive electrode material, and a method of manufacturing a solid-state battery.

### Related Art

Solid-state batteries are conventionally known as lithium ion secondary batteries having excellent stability. International Publication No. 2021/187391 discloses a positive electrode material. The positive electrode material that is disclosed concretely in International Publication No. 2021/187391 is formed from a positive electrode active material (Li(Ni,Co,Mn)O₂) whose surface is covered by a first solid electrolyte material (Li_{2.6}Ti_{0.4}Al_{0.6}F₆), and a second electrolyte material (Li₂S—P₂S₅).

### SUMMARY

However, at a solid-state battery using the positive electrode material that is disclosed concretely in International Publication No. 2021/187391, there is the concern that the initial resistance will be relatively high. Further, in a solid-state battery that uses a positive electrode material in which a conductive additive is added to the positive electrode material disclosed concretely in International Publication No. 2021/187391 in order to reduce the resistance, there is the concern that, if charging/discharging of the solid-state battery are repeated, it will be easy for the resistance of the solid-state battery to increase.

The present disclosure was made in view of the above-described circumstances. As a solution to the above-described problems, embodiments of the present disclosure provide a positive electrode material from which there can be manufactured a solid-state battery whose initial resistance is kept low and at which it is difficult for the resistance to increase even if charging/discharging are repeated, and a method of manufacturing the positive electrode material. As a solution to the above-described problems, other embodiments of the present disclosure provide a solid-state battery whose initial resistance is kept low and at which it is difficult for the resistance to increase even if charging/discharging are repeated, and a method of manufacturing the solid-state battery.

The following embodiments are included as means for solving the above-described problems.

<1> A positive electrode material including a positive electrode active material complex (A) and a sulfide solid electrolyte (B), wherein
the positive electrode active material complex (A) has:
a positive electrode active material (a);
a conductive additive (b) covering at least a portion of a surface of the positive electrode active material (a); and
a solid electrolyte (c) covering at least a portion of the conductive additive (b), and
the solid electrolyte (c) contains Li, Ti, X and F, and
the X is at least one selected from the group consisting of Ca, Mg, Al, Y and Zr.
   <2> The positive electrode material of <1>, wherein the X contains Al.
   <3> The positive electrode material of <1> or <2>, wherein:
the conductive additive (b) covers an entire surface of the positive electrode active material (a), and
the solid electrolyte (c) covers an entirety of the conductive additive (b).
   <4> A solid-state battery including a positive electrode layer, a negative electrode layer, and a solid electrolyte layer disposed between the positive electrode layer and the negative electrode layer,
wherein the positive electrode layer contains the positive electrode material of any one of <1> through <3>.
   <5> A method of manufacturing a positive electrode material including:
covering at least a portion of a surface of a positive electrode active material (a) with a conductive additive (b);
covering at least a portion of the conductive additive (b) with a solid electrolyte (c), and fabricating a positive electrode active material complex (A); and
kneading the positive electrode active material complex (A) and a sulfide solid electrolyte (B),
wherein the solid electrolyte (c) contains Li, Ti, X and F, and
the X is at least one selected from the group consisting of Ca, Mg, Al, Y and Zr.
   <6> The method of manufacturing a positive electrode material of <5>, wherein the X contains Al.
   <7> A method of manufacturing a solid-state battery including a step of fabricating a positive electrode material by the method of manufacturing a positive electrode material of <5> or <6>.

In accordance with the present disclosure, there are provided a positive electrode material from which there can be manufactured a solid-state battery whose initial resistance is kept low and at which it is difficult for the resistance to increase even if charging/discharging are repeated, and a method of manufacturing the positive electrode material. In accordance with the present disclosure, there are provided a solid-state battery whose initial resistance is kept low and at which it is difficult for the resistance to increase even if charging/discharging are repeated, and a method of manufacturing the solid-state battery.

### BRIEF DESCRIPTION OF THE DRAWINGS

Exemplary embodiments of the present invention will be described in detail based on the following figures, wherein:

FIG. 1 is a schematic sectional view illustrating an example of a solid-state battery;

FIG. 2 is a scanning electron microscope (SEM) photograph (magnification rate: 30,000×) of a positive electrode active material with conductive additive of Example 1;

FIG. 3 is an image from an SEM—energy-dispersive X-ray spectroscopy (EDS) analyzer in which the C distribution, the F distribution and the Ni distribution of a positive electrode active material complex of Example 1 are superposed;

FIG. 4 is an SEM-EDS image illustrating the C distribution of the positive electrode active material complex of Example 1;

FIG. 5 is an SEM-EDS image illustrating the F distribution of the positive electrode active material complex of Example 1; and

FIG. 6 is an SEM-EDS image illustrating the Ni distribution of the positive electrode active material complex of Example 1.

### DETAILED DESCRIPTION

In the disclosure, a numerical range indicated using “to” includes numerical values described before and after “to” as a minimum value and a maximum value, respectively. In the numerical ranges described in stages in the disclosure, the upper limit value or the lower limit value described in one numerical range may be replaced with the upper limit value or the lower limit value of the numerical range described in another stage. In the numerical value ranges put forth in the present disclosure, the upper limit value or the lower limit value listed in a given numerical value range may be substituted by a value set forth in the Examples. In the present disclosure, combinations of two or more preferable aspects are more preferable aspects. In the present disclosure, in a case in which there are plural types of materials that correspond to a component, the amount of that component means the total amount of the plural types of materials, unless otherwise indicated. In the present disclosure, the term “step” is not only an independent step, and includes steps that, in a case in which that step cannot be clearly distinguished from another step, achieve the intended object of that step.

(1) Positive Electrode Material

The positive electrode material of the present disclosure contains a positive electrode active material complex (A) and a sulfide solid electrolyte (B). The positive electrode active material complex (A) has a positive electrode active material (a), a conductive additive (b) covering at least a portion of the surface of the positive electrode active material (a), and a solid electrolyte (c) covering at least a portion of the conductive additive (b). The solid electrolyte (c) contains Li (lithium), Ti (titanium), X, and F (fluorine). The X is at least one selected from the group consisting of Ca (calcium), Mg (magnesium), Al (aluminum), Y (yttrium), and Zr (zirconium).

The “positive electrode active material complex (A)” contains plural positive electrode active material composite particles that contain the positive electrode active material (a), the conductive additive (b), and the solid electrolyte (c). The “sulfide solid electrolyte (B)” contains plural sulfide solid electrolyte (B) particles. The “positive electrode active material (a)” contains plural positive electrode active material (a) particles. The “conductive additive (b)” contains plural conductive additive (b) particles. The “solid electrolyte (c)” contains plural solid electrolyte (c) particles. Having “conductive additive (b) covering at least a portion of a surface of the positive electrode active material (a); and solid electrolyte (c) covering at least a portion of the conductive additive (b)” means that each of the plural positive electrode active material complex (A) particles may be in a form of having one positive electrode active material (a) particle, plural conductive additive (b) particles that cover at least a portion of the surface of the one positive electrode active material (a) particle, and plural solid electrolyte (c) particles that cover at least a portion of the plural conductive additive (b) particles.

Because the positive electrode material of the present disclosure has the above-described structure, the positive electrode active material can be used to manufacture a solid-state battery whose initial resistance is kept low and at which it is difficult for the resistance to increase even if charging/discharging are repeated. It is surmised that this effect is due to the following reasons, but is not limited to these. In the present disclosure, at least a portion of the surface of the positive electrode active material (a) is covered by the conductive additive (b). Therefore, as compared with a case in which the surface of the positive electrode active material (a) is not covered by the conductive additive (b), it is easier to ensure the uniformity of the electrochemical reaction and the electron conductivity of the entire positive electrode layer of the solid-state battery that uses the positive electrode material of the present disclosure. As a result, it is assumed that the initial resistance of the solid-state battery that uses the positive electrode material of the present disclosure is kept low. In a solid-state battery that uses a positive electrode material containing a conductive additive and a sulfide solid electrolyte, it is easy for the potential of the conductive additive to become high at the time of charging the solid-state battery. When the conductive additive whose potential is high and the sulfide solid electrolyte contact, it is easy for the sulfide solid electrolyte to decompose. As a result, there is the concern that an oxidative decomposition layer that becomes interface resistance will form between the positive electrode active material and the sulfide solid electrolyte. On the other hand, in the present disclosure, the solid electrolyte (c) contains Li, Ti, X and F. In other words, the solid electrolyte (c) is highly oxidation resistant such that it is difficult to decompose even under high voltage. Moreover, at least some of the conductive additive (b) that covers some of the surface of the positive electrode active material (a) is covered by the solid electrolyte (c). Namely, the surface area of contact between the conductive additive (b), which is made to cover the positive electrode active material (a), and the sulfide solid electrolyte (B) is smaller than in a case in which the solid electrolyte (c) is not made to cover the conductive additive (b). Therefore, at the time of charging the solid-state battery, even if the potential of the conductive additive (b) is high, it is difficult for the sulfide solid electrolyte (B) to decompose. In other words, it is difficult for an oxidative decomposition layer that becomes interface resistance to form between the positive electrode active material (a) and the sulfide solid electrolyte (B). As a result, it is assumed that, even if charging/discharging are repeated, it will be difficult for the resistance of a solid-state battery that uses the positive electrode material of the present disclosure to increase.

The form of the positive electrode material is not particularly limited, and may be a powder or may be a slurry.

(1.1) Positive Electrode Active Material Complex (A)

The positive electrode material contains the positive electrode active material complex (A).

The positive electrode active material complex (A) has the positive electrode active material (a), the conductive additive (b) covering at least a portion of the surface of the positive electrode active material (a), and the solid electrolyte (c) covering at least a portion of the conductive additive (b). The solid electrolyte (c) contains Li, Ti, X and F. The X is at least one selected from the group consisting of Ca, Mg, Al, Y, and Zr.

From the standpoint of obtaining a solid-state battery whose initial resistance is kept even lower, and the like, the coverage factor of the conductive additive (b) is preferably 30% or more, and more preferably 60% or more, and even more preferably 90% or more, and particularly preferably 100%. The coverage factor of the conductive additive (b) can be determined from the surface area ratio obtained by X-ray photoelectron spectroscopy (XPS) measurement. The thickness (hereinafter also called “first thickness”) of the conductive additive (b) that covers at least a portion of the surface of the positive electrode active material (a) is not particularly limited, and is preferably 5 nm or more, and more preferably from 10 nm to 100 nm. If the first thickness is within the aforementioned range, it is difficult for the movement of the lithium ions to be impeded. The first thickness is preferably 1% or more with respect to the median diameter of the positive electrode active material (a). Due thereto, the positive electrode material can be used to manufacture a solid-state battery whose initial resistance is kept even lower. The method of measuring the median diameter of the positive electrode active material (a) is similar to the measuring method described in the Examples. An example of the method of measuring the first thickness is a method in which SEM observation of a cross-section of the positive electrode active material complex (A) is carried out, and the first thickness is measured at five arbitrary points, and the average thickness is calculated.

From the standpoint of obtaining a solid-state battery at which it is even more difficult for the resistance to increase even if charging/discharging are repeated, and the like, the coverage factor of the solid electrolyte (c) is preferably 70% or more, and more preferably 80% or more, and even more preferably 90% or more, and particularly preferably 100%. The coverage factor of the solid electrolyte (c) can be determined from the surface area ratio obtained by X-ray photoelectron spectroscopy (XPS) measurement. The thickness (hereinafter also called “second thickness”) of the solid electrolyte (c) that covers at least a portion of the conductive additive (b) that covers at least a portion of the surface of the positive electrode active material (a) is not particularly limited, and is preferably 5 nm or more, and more preferably from 10 nm to 300 nm. If the second thickness is within the aforementioned range, it is difficult for the movement of the lithium ions to be impeded. The second thickness is preferably 1% or more with respect to the median diameter of the positive electrode active material (a). Due thereto, the positive electrode material can be used to manufacture a solid-state battery at which it is even more difficult for the resistance to increase even if charging/discharging are repeated. The method of measuring the median diameter of the positive electrode active material (a) is similar to the measuring method described in the Examples. An example of the method of measuring the second thickness is a method in which SEM observation of a cross-section of the positive electrode active material complex (A) is carried out, and the second thickness is measured at five arbitrary points, and the average thickness is calculated.

It is preferable that the conductive additive (b) covers an entire surface of the positive electrode active material (a), and the solid electrolyte (c) covers an entirety of the conductive additive (b). In other words, at each of the plural positive electrode active material complex (A) particles, it is preferable that the plural conductive additive (b) particles cover the entire surface of the one positive electrode active material (a) particle, and the plural solid electrolyte (c) particles cover the entireties of the plural conductive additive (b) particles that cover the entire surface of the one positive electrode active material (a) particle. Due thereto, the positive electrode material can be used to manufacture the solid-state battery whose initial resistance is kept even lower, and at which it is even harder for the resistance to increase even if charging/discharging are repeated.

(1.1.1) Positive Electrode Active Material (a)

The positive electrode active material (a) preferably contains a lithium complex oxide. The lithium complex oxide may contain at least one type selected from the group consisting of F, Cl, N, S, Br and I. Further, the lithium complex oxide may have a crystal structure belonging to at least one space group selected from space groups R-3 μm, Immm, and P63-mm (also called P63mc, P6/mmc). At the lithium complex oxide, the main sequence of a transition metal, oxygen and lithium may be an O2-type structure.

Examples of the lithium complex oxide having a crystal structure belonging to R-3m are compounds expressed by LiₓMe_{y}O_{α}X_{β} (Me represents at least one type selected from the group consisting of Mn, Co, Ni, Fe, Al, Cu, V, Nb, Mo, Ti, Cr, Zr, Zn, Na, K, Ca, Mg, Pt, Au, Ag, Ru, W, B, Si and P, and X represents at least one type selected from the group consisting of F, Cl, N, S, Br and I, and 0.5≤x≤1.5, 0.5≤y≤1.0, 1≤α<2, and 0<β≤1 are satisfied).

Examples of the lithium complex oxide having a crystal structure belonging to Immm are compounds expressed by Liₓ₁M¹A¹₂ (1.5≤x≤2.3 is satisfied, M¹ includes at least one type selected from the group consisting of Ni, Co, Mn, Cu and Fe, A¹ includes at least oxygen, and the ratio of oxygen contained in A¹ is 85 atom % or more) (a specific example is Li₂NiO₂), and compounds expressed by Liₓ₁M^{1A}₁₋ₓ₂M^{1B}ₓ₂O_{2-y}A²_{y} (0≤x2≤0.5, 0≤y≤0.3, at least one of x2 and y is not 0, M^{1A} represents at least one type selected from the group consisting of Ni, Co, Mn, Cu and Fe, M^{1B} represents at least one type selected from the group consisting of Al, Mg, Sc, Ti, Cr, V, Zn, Ga, Zr, Mo, Nb, Ta and W, and A2 represents at least one type selected from the group consisting of F, Cl, Br, S and P).

Examples of the lithium complex oxide having a crystal structure belonging to P63-mmc are compounds expressed by M1ₓM2_{y}O₂ (M1 represents an alkali metal (at least one of Na and K is preferable), M2 represents a transition metal (at least one selected from the group consisting of Mn, Ni, Co and Fe is preferable), and x+y satisfies 0<x+y≤2).

Examples of the lithium complex oxide having an 02 type structure are compounds expressed by Liₓ[Li_{α}(MnₐCo_{b}M_{c})_{1-α}]O₂ (0.5<x<1.1, 0.1<α<0.33, 0.17<a<0.93, 0.03<b<0.50, 0.04<c<0.33, and M represents at least one type selected from the group consisting of Ni, Mg, Ti, Fe, Sn, Zr, Nb, Mo, W and Bi). Li_{0.744}[Li_{0.145}Mn_{0.625}Co_{0.115}Ni_{0.115}]O₂ and the like are specific examples.

The shape of the positive electrode active material (a) particles is not particularly limited, and examples thereof are spherical (e.g., perfectly spherical, elliptically spherical, and the like), fiber-shaped, and the like. In the present disclosure, “spherical” means a particle of an aspect ratio of 0.1 to 1.0, and “fiber-shaped” means a particle of an aspect ratio exceeding 10. In a case in which the shape of the positive electrode active material (a) particles is spherical, the median diameter of the positive electrode active material (a) is preferably from 0.05 μm to 50 μm, and more preferably from 0.1 μm to 20 μm. The method of measuring the median diameter of the positive electrode active material (a) is similar to the measuring method described in the Examples.

(1.1.2) Conductive Additive (b)

Examples of the conductive additive (b) are carbon materials, metal materials, and conductive polymer materials. Examples of the carbon materials are carbon black (e.g., acetylene black, furnace black, ketjen black, and the like), filamentous carbon (e.g., vapor grown carbon fibers, carbon nanotubes, carbon nanofibers, and the like), graphite, fluorocarbons, and the like. Examples of the metal materials are metal powders (e.g., aluminum powder and the like, conductive whiskers (e.g., zinc oxide, potassium titanate, and the like), conductive metal oxides (e.g., titanium oxide and the like), and the like. Examples of the conductive polymer materials are polyaniline, polypyrrole, polythiophene, and the like. One type of conductive additive (b) may be used alone, or two or more types may be used by being mixed together.

The shape and size of the conductive additive (b) particles are not particularly limited. Examples of the shape of the conductive additive (b) particles are spherical (e.g., perfectly spherical, elliptically spherical, and the like), fiber-shaped, and the like. The shape of the conductive additive (b) particles is preferably spherical. By making the shape of the conductive additive (b) particles be particle-shaped, it is easy to cover the entire surface of one positive electrode active material (a) particle by plural conductive additive (b) particles.

In a case in which the conductive additive (b) particles are spherical, the median diameter of the conductive additive (b) is preferably smaller than the median diameter of the positive electrode active material (a). The median diameter of the conductive additive (b) with respect to the median diameter of the positive electrode active material (a) is preferably 0.1 times or less, and more preferably 0.02 times or less. If the median diameter of the conductive additive (b) is 0.1 times or less than the median diameter of the positive electrode active material, it is easy for the plural conductive additive (b) particles to cover the entire surface of the one positive electrode active material (a) particle. The median diameter of the conductive additive (b) is not particularly limited, and is preferably from 5 nm to 1000 nm, and more preferably from 15 nm to 100 nm. The method of measuring the median diameter of the conductive additive (b) is similar to the measuring method described in the Examples.

In a case in which the conductive additive (b) particles are fiber-shaped, the fiber diameter of the conductive additive (b) particles may be from 5 nm to 1 μm, and the aspect ratio of the conductive additive (b) particles may be 20 or more.

(1.1.3) Solid Electrolyte (c)

The solid electrolyte (c) includes Li, Ti, X, and F. The X is at least one selected from the group consisting of Ca, Mg, Al, Y, and Zr. Due thereto, the solid electrolyte (c) has high lithium ion conductivity and high oxidation resistance.

The shape of the solid electrolyte (c) particles is not particularly limited and is, for example, spherical (e.g., perfectly spherical, elliptically spherical, and the like), fiber-shaped, and the like. In a case in which the solid electrolyte (c) particles are spherical, the median diameter of the solid electrolyte (c) is preferably smaller than the median diameter of the positive electrode active material (a). The median diameter of the solid electrolyte (c) with respect to the median diameter of the positive electrode active material is preferably 0.1 times or less, and more preferably 0.02 times or less. If the median diameter of the solid electrolyte (c) is 0.1 times or less than the median diameter of the positive electrode active material, it is easy for the plural solid electrolyte (c) particles to cover the entireties of the plural conductive additive (b) particles that cover the surface of the one positive electrode active material (a) particle. The median diameter of the solid electrolyte (c) is preferably from 10 nm to 1000 nm, and more preferably from 10 nm to 200 nm. The method of measuring the median diameter of the solid electrolyte (c) is similar to the measuring method described in the Examples.

X more preferably contains Al, and even more preferably is Al. Due to X containing Al, the lithium conductivity of the solid electrolyte (c) is higher than in a case in which X does not contain Al. As a result, the positive electrode material can be used to manufacture a solid-state battery whose resistance is even lower.

In a case in which X contains Al, the ratio of the material amount of the Li with respect to the total of the material amounts of Al and Ti may be 1.7 to 4.2.

In a case in which X contains Al, the solid electrolyte (c) preferably contains a material expressed by following composition formula (1), and more preferably is formed from a material expressed by following composition formula (1). The material expressed by composition formula (1) may be a crystal phase.

Li_{6-(4-x)b}(Ti₁₋ₓMₓ)_{b}F₆ formula (1)

In formula (1), x is 0<x<1, and b is 0<b≤1.5.
Due to the solid electrolyte (c) containing a material expressed by above composition formula (1), the lithium conductivity of the solid electrolyte (c) is higher. As a result, the resistance of the solid-state battery is lower.
In formula (1), x may be 0.1≤x≤0.9, and b may be 0.8≤b≤1.2.

The composition of the solid electrolyte (c) preferably contains Li_{2.7}Ti_{0.3}Al_{0.7}F₆, and more preferably is Li_{2.7}Ti_{0.3}Al_{0.7}F₆. Due to the composition of the solid electrolyte (c) containing Li_{2.7}Ti_{0.3}Al_{0.7}F₆, the lithium conductivity of the solid electrolyte (c) is even higher. As a result, the resistance of the solid-state battery is even lower.

(1.2) Sulfide Solid Electrolyte (B)

The positive electrode material contains the sulfide solid electrolyte (B).

It is preferable that the sulfide solid electrolyte (B) contain sulfur (S) as the main component that is an anion element, and it is more preferable that the sulfide solid electrolyte (B) contain, for example, the element Li, an element A, and the element S. Element A is at least one type selected from the group consisting of P, As, Sb, Si, Ge, Sn, B, Al, Ga and In. The sulfide solid electrolyte (B) may further contain at least one of O and a halogen element. Examples of the halogen element (X) are F, Cl, Br, I and the like. The composition of the sulfide solid electrolyte (B) is not particularly limited, and examples are xLi₂S·(100-x)P₂S₅ (70≤x≤80) and yLiI·zLiBr·(100-y-z)(xLi₂S·(1-x)P₂S₅) (0.7≤x≤0.8, 0≤y≤30, 0≤z≤30). The sulfide solid electrolyte (B) may have a composition expressed by following general formula (2).

Li₄₋ₓGe₁₋ₓPₓS₄(0<x<1) formula (2)

In formula (2), at least some of the Ge may be substituted by at least one selected from the group consisting of Sb, Si, Sn, B, Al, Ga, In, Ti, Zr, V and Nb. Further, at least some of the P may be substituted by at least one selected from the group consisting of Sb, Si, Sn, B, Al, Ga, In, Ti, Zr, V and Nb. At least some of the Li may be substituted by at least one selected from the group consisting of Na, K, Mg, Ca and Zn. Some of the S may be substituted by a halogen. The halogen is at least one of F, Cl, Br and I.

The shape of the sulfide solid electrolyte (B) particles is not particularly limited, and examples thereof are spherical (e.g., perfectly spherical, elliptically spherical, and the like), fiber-shaped, and the like. In a case in which the sulfide solid electrolyte (B) particles are spherical, the median diameter of the sulfide solid electrolyte (B) is preferably smaller than the median diameter of the positive electrode active material (a). The median diameter of the sulfide solid electrolyte (B) is preferably 0.1 times or less than the median diameter of the positive electrode active material. If the median diameter of the sulfide solid electrolyte (B) is 0.1 times or less than the median diameter of the positive electrode active material, the initial resistance of the obtained solid-state battery is kept even lower. The median diameter of the sulfide solid electrolyte (B) is preferably from 0.05 μm to 3.0 μm. The method of measuring the median diameter of the sulfide solid electrolyte (B) is similar to the measuring method described in the Examples.

The compounding ratio of the sulfide solid electrolyte (B) is not particularly limited, and, with respect to the total amount of the positive electrode active material complex (A), is preferably from 5 mass % to 70 mass %, and more preferably from 10 mass % to 45 mass %.

(1.3) Binder (C)

The positive electrode material may contain the binder (C), or may not contain the binder (C). The binder (C) improves the adhesion of the positive electrode active material complex (A) and the sulfide solid electrolyte (B).

Examples of the binder (C) are vinyl halide resins, rubbers, polyolefin resins, and the like. Examples of vinyl halide resins are polyvinylidene fluoride (PVdF), copolymers (PVdF-HFP) of polyvinylidene fluoride and hexafluoropropylene, and the like. Examples of polyolefin resins are butadiene rubber (BR), acrylate-butadiene rubber (ABR), styrene-butadiene rubber (SBR), acrylonitrile-butadiene rubber (NBR), butyl rubber (isobutylene-isoprene rubber), and the like. Examples of polyolefin resins are polyethylene, polypropylene, and the like. The binder (C) may be a diene rubber containing a double bond in the main chain, e.g., butadiene rubber in which 30 mol % or more of the entire amount is butadiene.

In a case in which the positive electrode material contains the binder (C), the compounding ratio of the binder (C) is not particularly limited, and, with respect to the total amount of the positive electrode active material complex (A), is preferably from 0.1 mass % to 20 mass %, and more preferably from 0.1 mass % to 10 mass %, and even more preferably from 0.1 mass % to 5 mass %.

(1.4) Solvent (D)

The positive electrode material may contain the solvent (D), or may not contain the solvent (D). Due to the positive electrode material containing the solvent (D), the form of the positive electrode material can be made to be a slurry. It suffices for the solvent (D) to be a known solvent that is used in the manufacturing of solid-state batteries.

(1.5) Other Components (E)

The positive electrode material may contain other components (E), or may not contain other components (E). Examples of the other components (E) are oxide solid electrolytes, halide solid electrolytes, thickeners, surfactants, dispersants, wetting agents, antifoaming agents, and the like.

The positive electrode material may be formed from the positive electrode active material complex (A) and the sulfide solid electrolyte (B). The positive electrode material may be formed from the positive electrode active material complex (A), the sulfide solid electrolyte (B), and the binder (C). The positive electrode material may be formed from the positive electrode active material complex (A), the sulfide solid electrolyte (B), the binder (C), and the solvent (D).

(2) Solid-State Battery

The solid-state battery of the present disclosure has a positive electrode layer, a negative electrode layer, and a solid electrolyte layer disposed between the positive electrode layer and the negative electrode layer. The positive electrode layer contains the positive electrode material of the present disclosure.

Because the solid-state battery of the present disclosure has the above-described structure, the initial resistance is kept low, and it is difficult for the resistance to increase even if charging/discharging are repeated. It is assumed that this effect is due to reasons similar to those of the above-described effect of the positive electrode material of the present disclosure, but is not limited to this.

(2.1) Battery Structure

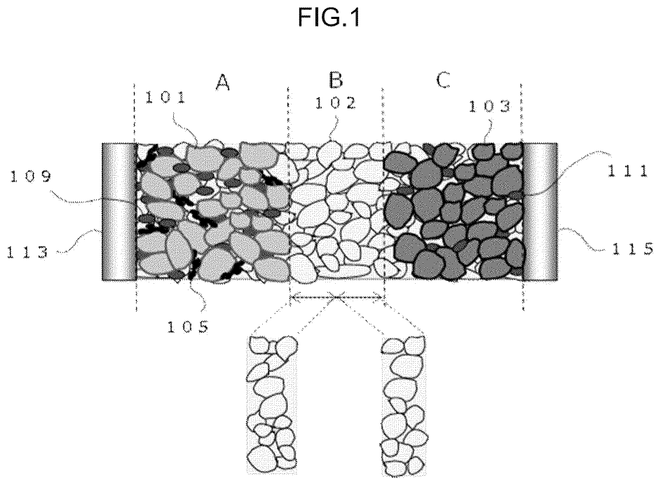

The solid-state battery includes so-called all-solid-state batteries that use an inorganic solid electrolyte as the electrolyte (i.e., structures in which all of the electrolyte at the battery interior is solid). The structure of the solid-state battery of the present disclosure may be a structure having a positive electrode collector, a positive electrode layer, a solid electrolyte layer, a negative electrode layer and a negative electrode collector in that order, e.g., may be the structure illustrated in FIG. 1. A solid electrolyte layer B in FIG. 1 may be a two-layer structure. FIG. 1 is a schematic sectional view illustrating an example of the solid-state battery. The solid-state battery illustrated in FIG. 1 has a negative electrode including a negative electrode collector 113 and a negative electrode layer A, and the solid electrolyte layer B, and a positive electrode including a positive electrode collector 115 and a positive electrode layer C. The negative electrode layer A includes a negative electrode active material 101, a conductive additive 105, a binder 109, and a solid electrolyte 102. The positive electrode layer C includes a positive electrode active material complex 103, a binder 111, and the solid electrolyte 102.

Given that the set of the positive electrode layer, the solid electrolyte layer and the negative electrode layer is the power generating unit, the solid-state battery may have only one power generating unit or may have two or more power generating units. In a case in which the solid-state battery has two or more power generating units, these power generating units may be connected in series or may be connected in parallel.

The solid-state battery may be structured such that the layer end surfaces (side surfaces) of a layered structure of a positive electrode layer/a solid electrolyte layer/a negative electrode layer are sealed by a resin. The collector of the electrode may be a structure in which a shock-absorbing layer, an elastic layer or a PTC (Positive Temperature Coefficient) thermistor layer is disposed on the surface of the collector. The shape of the solid-state battery is not particularly limited, and may be, for example, coin-shaped, cylindrical, square, sheet-shaped, button-shaped, flat, layered, or the like.

(2.2) Solid Electrolyte Layer

The solid-state battery has a solid electrolyte layer. The solid electrolyte layer preferably contains one selected from the group consisting of sulfide solid electrolytes, oxide solid electrolytes and halide solid electrolytes.

Examples of sulfide solid electrolytes are similar to those exemplified as the sulfide solid electrolyte (B). The sulfide solid electrolyte contained in the solid electrolyte layer may be the same as the sulfide solid electrolyte (B), or may be different than the sulfide solid electrolyte (B).

The oxide solid electrolyte preferably contains oxygen (O) as the main component that is an anion element, and, for example, may contain Li, element Q (Q represents at least one of Nb, B, Al, Si, P, Ti, Zr, Mo, W and S), and O. Examples of the oxide solid electrolyte are garnet type solid electrolytes, perovskite type solid electrolytes, NASICON type solid electrolytes, Li—P—O solid electrolytes, Li—B—O solid electrolytes, and the like. Examples of garnet type solid electrolytes are Li₇La₃Zr₂O₁₂, Li₇₋ₓLa₃(Zr₂₋ₓNbₓ)O₁₂ (0≤x≤2), Li₅La₃Nb₂O₁₂, and the like. Examples of perovskite type solid electrolytes are (Li,La)TiO₃, (Li,La)NbO₃, (Li,Sr)(Ta,Zr)O₃ and the like. Examples of NASICON type solid electrolytes are Li(Al,Ti)(PO₄)₃, Li(Al,Ga)(PO₄)₃, and the like. Examples of Li—P—O solid electrolytes are Li₃PO₄, UPON (compounds in which some of the O in Li₃PO₄ is substituted with N). Examples of Li—B—O solid electrolytes are Li₃BO₃, compounds in which some of the O in Li₃BO₃ is substituted with C, and the like.

As the halide solid electrolyte, solid electrolytes containing Li, M and X (M represents at least one of Ti, Al and Y, and X represents F, Cl or Br) are suitable. Specifically, Li_{6-3z}Y_{z}X₆ (X represents Cl or Br, and z satisfies 0<z<2) and Li_{6-(4-x)b}(Ti₁₋ₓAlₓ)_{b}F₆ (0<x<1, 0<b≤1.5) are preferable. Among Li_{6-3z}Y_{z}X₆, from the standpoint having excellent lithium ion conductivity, Li₃YX₆ (X represents Cl or Br) is more preferable, and Li₃YCl₆ is even more preferable. Further, from standpoints such as, for example, suppressing oxidative decomposition of the sulfide solid electrolyte and the like, it is preferable that Li_{6-(4-x)b}(Ti₁₋ₓAlₓ)_{b}F₆ (0<x<1, 0<b≤1.5) be contained together with a solid electrolyte such as a sulfide solid electrolyte or the like.

The solid electrolyte layer may be a single-layer structure, or may be a multilayer structure of two or more layers.

The solid electrolyte layer may contain a binder, or may not contain a binder. Examples of the binder that can be contained in the solid electrolyte layer are similar to those exemplified as the binder (C).

(2.3) Positive Electrode Layer

The solid-state battery has a positive electrode layer. The positive electrode layer contains the positive electrode material of the present disclosure.

(2.4) Positive Electrode Collector

The solid-state battery may further have a positive electrode collector. The positive electrode collector carries out current collection of the positive electrode layer. The positive electrode collector is disposed at a position at the side opposite the solid electrolyte layer, with the positive electrode layer as the reference.

Examples of the positive electrode collector are stainless steel, aluminum, copper, nickel, iron, titanium, carbon and the like, and an aluminum alloy film or an aluminum film is preferable. The aluminum alloy film or aluminum film may be manufactured by using a powder. Examples of the form of the positive electrode collector are the form of a foil and the form of a mesh. The positive electrode collector may be a structure in which a shock-absorbing layer, an elastic layer or a PTC (Positive Temperature Coefficient) thermistor layer is disposed on the surface thereof.

(2.5) Negative Electrode Layer

The solid-state battery has a negative electrode layer. The negative electrode layer contains a negative electrode active material. As needed, the negative electrode layer may contain at least one of a solid electrolyte for the negative electrode, a conductive additive, and a binder. Examples of the negative electrode active material are lithium-based active materials such as metallic lithium and the like, carbon-based active materials such as graphite and the like, oxide-based active materials such as lithium titanate and the like, and Si-based active materials such as Si alone and the like. Examples of the conductive additive, the solid electrolyte for the negative electrode, and the binder that are used in the negative electrode layer are similar to those exemplified as the conductive additive contained in the positive electrode layer, the solid electrolyte contained in the solid electrolyte layer, and the binder (C).

(2.6) Negative Electrode Collector

The solid-state battery may further have a negative electrode collector. The negative electrode collector carries out current collection of the negative electrode layer. The negative electrode collector is disposed at a position at the side opposite the solid electrolyte layer, with the negative electrode layer as the reference. Examples of the negative electrode collector are stainless steel, aluminum, copper, nickel, iron, titanium, carbon and the like, and copper is preferable. Examples of the form of the negative electrode collector are the form of a foil and the form of a mesh. The negative electrode collector may be a structure in which a shock-absorbing layer, an elastic layer or a PTC (Positive Temperature Coefficient) thermistor layer is disposed on the surface thereof.

(3) Method of Manufacturing Positive Electrode Material

The method of manufacturing the positive electrode material of the present disclosure includes covering with the conductive additive (b) (hereinafter also called “first covering step”), preparing the positive electrode active material complex (A) (hereinafter also called “second covering step”), and kneading the positive electrode active material complex (A) and the sulfide solid electrolyte (B) (hereinafter also called “kneading step”). The first covering step, the second covering step and the kneading step are executed in that order. The positive electrode material of the present disclosure is obtained thereby.

(3.1) First Covering Step

In the first covering step, at least portions of the respective surfaces of the positive electrode active material (a) are covered by the conductive additive (b). Due thereto, a positive electrode active material with conductive additive is obtained. The positive electrode active material with conductive additive contains plural particles of the positive electrode active material with conductive additive. One particle of the positive electrode active material with conductive additive has one positive electrode active material (a) particle, and plural conductive additive (b) particles that cover at least a portion of the surface of the one positive electrode active material (a) particle.

Examples of the positive electrode active material (a) in the first covering step are similar to those exemplified as the positive electrode active material (a) of the positive electrode material. Examples of the conductive additive (b) in the first covering step are similar to those exemplified as the conductive additive (b) of the positive electrode material.

The method of covering at least a portion of the surface of each positive electrode active material (a) by the conductive additive (b) (hereinafter also called “first covering method”) is not particularly limited, and examples are a method of mixing the two types of materials in a mortar, a method of applying shearing force to the two types of materials by using rotating blades, a method of causing the two types of materials to collide by using air jetting, a physical vapor deposition method (e.g., vacuum deposition, ion plating, sputtering, and the like), a chemical vapor deposition method (e.g., thermal CVD, plasma CVD, and the like), a sol-gel method, and the like.

(3.2) Second Covering Step

In the second covering step, at least a portion of the conductive additive (b) that is contained in the positive electrode active material with conductive additive is covered by the solid electrolyte (c), and the positive electrode active material complex (A) is prepared.

Examples of the solid electrolyte (c) in the second covering step are similar to those exemplified as the solid electrolyte (c) of the positive electrode material. Namely, the solid electrolyte (c) of the second covering step contains Li, Ti, X, and F. The X is at least one selected from the group consisting of Ca, Mg, Al, Y and Zr.

X more preferably contains Al, and even more preferably is Al. Due to X containing Al, the lithium conductivity of the solid electrolyte (c) is higher than in a case in which X does not contain Al. As a result, a solid-state battery whose resistance is lower is obtained.

The method of covering at least a portion of the conductive additive (b), which is contained in the positive electrode active material with conductive additive, by the solid electrolyte (c) (hereinafter also called “second covering method”) is not particularly limited, and examples thereof are methods similar to the methods exemplified as the first covering method. The second covering method may be the same as the first covering method, or may be different than the first covering method.

(3.3) Kneading Step

In the kneading step, the positive electrode active material complex (A) and the sulfide solid electrolyte (B) are kneaded. The positive electrode material is obtained thereby.

Examples of the sulfide solid electrolyte (B) in the kneading step are similar to those exemplified as the sulfide solid electrolyte (B) of the positive electrode material. At the time of kneading the positive electrode active material complex (A) and the sulfide solid electrolyte (B), the above-described binder (C), solvent (D) and other components (E) may be added as needed.

The method of kneading the positive electrode active material complex (A) and the sulfide solid electrolyte (B) is not particularly limited, and examples are methods of kneading by using a kneading device, or the like. Examples of the kneading device are an ultrasonic homogenizer, a shaker, a thin-film spin system mixer, a dissolver, a homo mixer, a kneader, a roll mill, a sand mill, an attritor, a ball mill, a vibrator mill, and a high-speed impeller mill.

(4) Method of Manufacturing Solid-State Battery

The method of manufacturing the solid-state battery includes a step (hereinafter also called “first preparation step”) of fabricating the positive electrode material by the method of manufacturing a positive electrode material of the present disclosure. The solid-state battery of the present disclosure is thereby obtained.

The method of manufacturing the solid-state battery of the present disclosure may include the first preparation step, and preparing a material for the negative electrode layer (hereinafter also called “second preparation step”), and preparing a material for the solid electrolyte layer (hereinafter also called “third preparation step”), and fabricating the solid-state battery (hereinafter also called “layering step”). The first preparation step, the second preparation step and the third preparation step are executed before the layering step is executed. The order of execution of the first preparation step, the second preparation step and the third preparation step is not particularly limited.

(4.1) First Preparation Step

The first preparation step is a step of fabricating the positive electrode material by the method of manufacturing a positive electrode material of the present disclosure. The positive electrode material of the present disclosure is thereby obtained.

(4.2) Second Preparation Step

The material for the negative electrode is prepared in the second preparation step. Examples of the material for the negative electrode are those exemplified as the material for the negative electrode layer of the solid-state battery. It suffices for the method of preparing the material for the negative electrode to be a known method.

(4.3) Third Preparation Step

The material for the solid electrolyte layer is prepared in the third preparation step. Examples of the material for the solid electrolyte layer are those exemplified as the material for the solid electrolyte layer of the solid-state battery. It suffices for the method of preparing the material for the solid electrolyte layer to be a known method.

(4.4) Layering Step

The solid-state battery having the positive electrode layer, the solid electrolyte layer and the negative electrode layer in that order is fabricated in the layering step. The positive electrode layer is formed by using the positive electrode material of the present disclosure. The solid electrolyte layer is formed by using the material for the solid electrolyte layer. The negative electrode layer is formed by using the material for the negative electrode layer.

A press method is an example of the method of fabricating the solid-state battery. The order in which the positive electrode layer, the solid electrolyte layer and the negative electrode layer are formed is not particularly limited. For example, the solid electrolyte layer may be formed by pressing, and thereafter, the positive electrode layer may be formed on one surface side of the solid electrolyte layer by pressing, and thereafter, the negative electrode layer may be formed on the other surface side of the solid electrolyte layer by pressing. Two or more layers among the positive electrode layer, the solid electrolyte layer and the negative electrode layer may be formed simultaneously by pressing. Slurries may be used at the time of forming the positive electrode layer, the solid electrolyte layer and the negative electrode layer. Examples of pressing techniques are roll pressing, cold isostatic pressing (CIP), and the like.

The pressure at the time of pressing is preferably greater than or equal to 0.1 t/cm², and more preferably greater than or equal to 0.5 t/cm², and even more preferably greater than or equal to 1 t/cm². The pressure at the time of pressing is preferably less than or equal to 10 t/cm², and more preferably less than or equal to 8 t/cm², and even more preferably less than or equal to 6 t/cm².

### EXAMPLES

The present disclosure is described in further detail hereinafter by way of Examples, but the invention of the present disclosure is not limited to these Examples.

### [1] Example 1

### [1.1] Preparation Step

The following positive electrode active material (a1), conductive additive (b1), solid electrolyte (c1) (hereinafter also called “LTAF (c1)”), sulfide solid electrolyte (B1) and binder (C1) were prepared.

[1.1.1.] Positive Electrode Active Material (a1)

A powder including plural core-shell-type composite particles (median diameter: 5 μm, density: 4.7 g/cm³) was prepared as the positive electrode active material (a1). The core-shell-type composite particles had a core formed from Li(Ni,Co,Al)O₂ and a shell formed from LiNbO₃. The median diameter of the positive electrode active material (a1) was measured by using a laser diffraction particle size analyzer (“SALD-2000”, Shimadzu Corporation). In detail, the positive electrode active material (a1) was dispersed in a dispersion medium, the volume-based particle diameter distribution was measured by using the particle size analyzer, and the particle diameter, at which the value of the obtained volume-based cumulative particle diameter distribution corresponded to 50%, was used as the median diameter.

[1.1.2] Conductive Additive (b1)

A powder (“Li-435” manufactured by Denka Company Limited, average particle diameter: 23 nm, density: 2.1 g/cm³), which was formed from plural acetylene black particles, was prepared as the conductive additive (b1).

[1.1.3] Solid Electrolyte (c1)

Within a glove box that had been purged with argon gas, LiF, TiF₄ and AlF₃ were placed in a container so as to be in a mole ratio (LiF:TiF₄:AlF₃) of 2.7:0.3:0.7, and a raw material powder was obtained. Next, the raw material powder was subjected to milling processing by using a planetary ball mill for 12 hours at a rotational speed of 500 rpm. A powder (median diameter: 10 nm to 100 nm, density: 2.7 g/cm³) formed from plural solid electrolyte particles was thereby obtained as the solid electrolyte (c1). The composition of the solid electrolyte particles was Li_{2.7}Ti_{0.3}Al_{0.7}F₆. The median diameter of the solid electrolyte (c1) was calculated by measuring the diameters of plural solid electrolyte particles by using a scanning electron microscope (SEM) image.

[1.1.4] Sulfide Solid Electrolyte (B1)

A powder (median diameter: 1.0 μm, density: 2.2 g/cm³) formed from plural LiI—LiBr—Li₂S—P₂S₅ glass ceramic particles was prepared as the sulfide solid electrolyte (B1). The median diameter of the sulfide solid electrolyte (B1) was calculated by measuring the diameters of plural glass ceramic particles by using an SEM image.

[1.1.5] Binder (C1)

A solution in which a butadiene rubber binder (density: 0.9 g/cm³) was dissolved in a dispersion medium (D1) was prepared as the binder (C1). The content of the butadiene rubber binder, with respect to the total amount of the solution, was 5 mass %.

[1.2] First Covering Step

The positive electrode active material (a1) and the conductive additive (b1) were placed in and kneaded in an agate mortar so as to be in a mass ratio of positive electrode active material (a1): conductive additive (b1)=99.5:0.5. Due thereto, a powder formed from plural particles of a positive electrode active material with conductive additive was obtained as the positive electrode active material with conductive additive.

[1.3] SEM Analysis

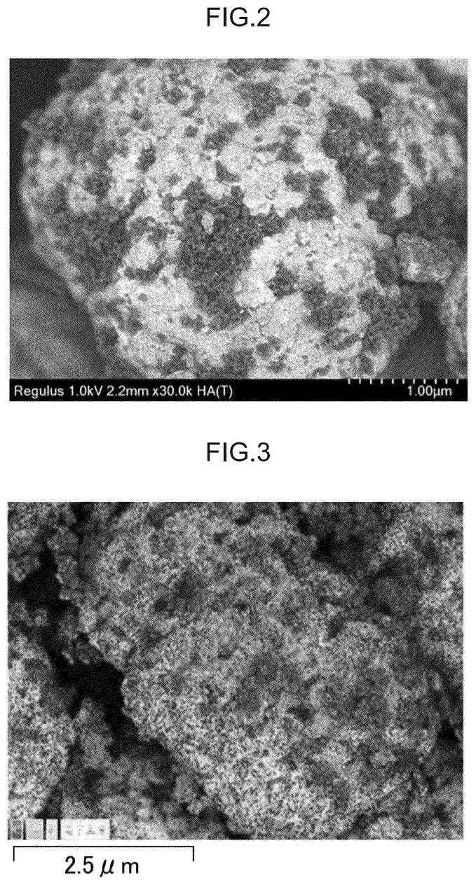

An SEM image (magnification: 30,000×) of particles of the positive electrode active material with conductive additive is shown in FIG. 2. A scanning electron microscope (SEM) (“Regulus 8230” manufactured by Hitachi High-Tech Corporation) was used in capturing the SEM image. The acceleration voltage was 1 kV. From the SEM image, it was confirmed that the conductive additive (b1) covered the majority of the surface of the positive electrode active material (a1). In particular, as shown in FIG. 2, it was understood that a large amount of the conductive additive (b1) exists within the recesses of the surface of the positive electrode active material (a1).

[1.4] Second Covering Step

The positive electrode active material with conductive additive and LTAF (c1) were, together with plural zirconia balls (diameter: 3 mm), placed in a container so as to be in a mass ratio (positive electrode active material with conductive additive: LTAF (c1)) of 94:6, and a mixture was obtained. Next, the mixture was kneaded by using a rotation-revolution mixer (“ARE-310” manufactured by Thinky Corporation) for 6 minutes at a rotational speed of 1200 rpm. A powder formed from plural positive electrode active material complex (Al) particles was thereby obtained as the positive electrode active material complex (Al).

[1.5] SEM-EDS Surface Element Analysis

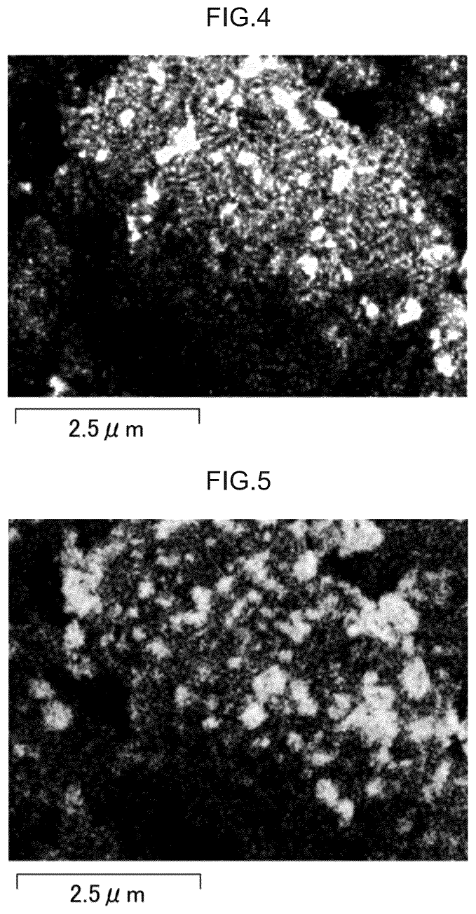

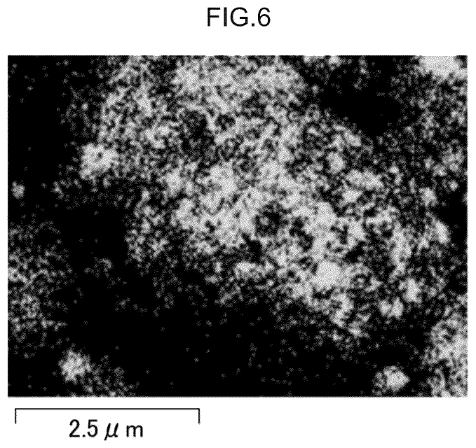

SEM-EDS images of the same one place of the positive electrode active material complex (Al) are shown in FIG. 3 through FIG. 6. FIG. 3 illustrates results of mapping in which the C component (corresponding to the conductive additive (b1)), the F component (corresponding to LTAF (c1)), and the Ni component (corresponding to the positive electrode active material (a1)) were overlapped. FIG. 4 illustrates the results of mapping of the C component (corresponding to the conductive additive (b1)). FIG. 5 illustrates the results of mapping of the F component (corresponding to LTAF (c1)). FIG. 6 illustrates the results of mapping of the Ni component (corresponding to the positive electrode active material (a1)). Note that, in FIG. 4 through FIG. 6, the regions where the color is bright indicate the portions covered by the C component, the F component and the Ni component, respectively. From FIG. 3 through FIG. 6, it can be understood that the conductive additive (b1) and the solid electrolyte (c1) exist uniformly at the entire surface of the positive electrode active material (a1). In other words, it can be understood that one particle of the positive electrode active material complex (Al) has one positive electrode active material (a1) particle, plural conductive additive (b1) particles that cover the majority of the surface of the one positive electrode active material (a1) particle, and plural LTAF (c1) particles that cover substantially the entireties of the plural conductive additive (b1) particles.

[1.6] Kneading Step

The positive electrode active material complex (Al), the sulfide solid electrolyte (B1) and the binder (C1) were weighed-out so as to be in a mass ratio (positive electrode active material complex (A1): sulfide solid electrolyte (B1): binder (C1)) of 83.8:15.8:0.4. The dispersing medium (D1) was added thereto, and kneading was carried out. A positive electrode mixture slurry was thereby obtained as the positive electrode material.

[2] Comparative Example 1

### [2.1] First Covering Step

A first covering step was not carried out.

[2.2] Second Covering Step Positive electrode active material complex (X1) was obtained in the same way as in the second covering step of Example 1, except that the positive electrode active material (a1) was used instead of a positive electrode active material with conductive additive. The positive electrode active material complex (X1) was formed from plural positive electrode active material complex (X1) particles. One of the plural positive electrode active material complex (X1) particles was formed from one positive electrode active material (a1) particle and plural LTAF (c1) particles that covered substantially the entire surface of the one positive electrode active material (a1) particle.

[2.3] Kneading Step

The positive electrode active material complex (X1), the sulfide solid electrolyte (B1) and the binder (C1) were weighed-out so as to be in a mass ratio (positive electrode active material complex (X1): sulfide solid electrolyte (B1): binder (C1)) of 83.8:15.8:0.4.

The dispersing medium (D1) was added thereto, and kneading was carried out. A positive electrode mixture slurry was thereby obtained as the positive electrode material.

[3] Comparative Example 2

### [3.1] First Covering Step and Second Covering Step

The positive electrode active material complex (X1) was obtained in the same way as in Example 1.

[3.2] Kneading Step

The positive electrode active material complex (X1), the sulfide solid electrolyte (B1), the binder (C1) and the conductive additive (b1) were weighed-out so as to be in a mass ratio (positive electrode active material complex (X1): sulfide solid electrolyte (B1): binder (C1): conductive additive (b1)) of 83.4:15.8:0.4:0.4. The dispersing medium (D1) was added thereto, and kneading was carried out. A positive electrode mixture slurry was thereby obtained as the positive electrode material.

[4] Comparative Example 3

### [4.1] First Covering Step

A first powder was obtained in the same way as in the first covering step of Example 1.

[4.2] Second Covering Step

Positive electrode active material complex (X2) was obtained in the same way as in the second covering step of Example 1, except that the positive electrode active material with conductive additive and the sulfide solid electrolyte (B1) were, together with plural zirconia balls (diameter: 3 mm), placed in a container so as to be in a mass ratio (positive electrode active material with conductive additive:sulfide solid electrolyte (B1)) of 95:5. The positive electrode active material complex (X2) was formed from one positive electrode active material (a1) particle, plural conductive additive (b1) particles that covered the majority of the surface of the positive electrode active material (a1) particle, and plural sulfide solid electrolyte (B1) particles that covered substantially the entireties of the plural conductive additive (b1) particles.

[4.3] Kneading Step

The positive electrode active material complex (X2), the sulfide solid electrolyte (B1) and the binder (C1) were weighed-out so as to be in a mass ratio (positive electrode active material complex (X2): sulfide solid electrolyte (B1): binder (C1)) of 83.7:15.9:0.4. The dispersing medium (D1) was added thereto, and kneading was carried out. A positive electrode mixture slurry was thereby obtained as the positive electrode material.

[5] Evaluation

By using the positive electrode materials of Example 1 and Comparative Examples 1 through 3, batteries for evaluation were fabricated as follows, and the initial resistance and resistance increase rate were evaluated. The results of evaluation are shown in Table 1.

[5.1] Battery for Evaluation

### [5.1.1] Positive Electrode

A positive electrode mixture slurry (positive electrode material) was coated on a collector foil and dried at 100° C., and a positive electrode was obtained. The positive electrode was formed from the collector foil and a positive electrode mixture layer formed on the collector foil. The thickness of the positive electrode mixture layer was adjusted such that, in the measuring of the battery capacity in the initial stage that is described later, the discharge capacity was 2 mAh/cm².

[5.1.2] Negative Electrode

A powder formed from plural Li₄Ti₅O₁₂ particles (median diameter: 1.1 μm, density: 3.5 g/cm³) was prepared as the negative electrode active material. The method of measuring the median diameter of the negative electrode active material is similar to the method of measuring the median diameter of the positive electrode active material. A solution in which a butadiene rubber binder was dissolved in advance in a dispersing medium was prepared as the binder. The content of the butadiene rubber binder was 1.5 mass % with respect to the total amount of the solution. Carbon fibers (“VGCF-H” manufactured by Showa Denko, average fiber diameter: 0.15 μm, average fiber length: 6 μm, density: 2.1 g/cm³) were prepared as the conductive additive.

The negative electrode active material, the sulfide solid electrolyte, the binder and the conductive additive were weighed-out so as to be in a mass ratio (negative electrode active material:sulfide solid electrolyte:binder:conductive additive) of 73.8:24.8:0.6:0.8. The dispersing medium (D1) was added thereto, and kneading was carried out. A negative electrode mixture slurry was thereby obtained.

The negative electrode mixture slurry was coated on a collector foil and dried at 100° C., and a negative electrode was obtained. The negative electrode was formed from the collector foil and a negative electrode mixture layer formed on the collector foil. The thickness of the negative electrode mixture layer was adjusted such that a first capacity per unit surface area of the negative electrode was 1.15 times a second capacity per unit surface area of the positive electrode. “First capacity per unit surface area of the negative electrode” means the capacity per unit surface area of the negative electrode when the specific capacity of the negative electrode active material was made to be 175 mAh/g. “Second capacity per unit surface area of the positive electrode” means the charge capacity of the first time in the measuring of the battery capacity in the initial stage that is described later.

[5.1.3] Solid Electrolyte Layer

LiI—LiBr—Li₂S—P₂S₅ glass ceramic particles (median diameter: 2.5 μm, density: 2.2 g/cm³) were prepared as the solid electrolyte. The median diameter was calculated by measuring diameters of the solid electrolyte from a scanning electron microscope image of the particles. The median diameters of the solid electrolyte and the above-described sulfide solid electrolyte (B1) were different. A butadiene rubber binder was prepared as the binder. The binder was dissolved in a dispersing medium in advance, and used as a solution of 5 mass %.

The solid electrolyte and the butadiene rubber binder were weighed-out so as to be in a mass ratio (solid electrolyte:butadiene rubber binder) of 99.6:0.4. The dispersing medium (D1) was added thereto, and kneading was carried out. A solid electrolyte slurry was thereby obtained.

[5.1.4] Positive Electrode Side Layered Body

The solid electrolyte slurry was coated on the surface of the positive electrode mixture layer and dried at 100° C. Thereafter, roll pressing was carried out at 2 ton/cm², and the positive electrode side layered body was obtained. The positive electrode side layered body had a positive electrode and a solid electrolyte layer formed on the surface of the positive electrode.

[5.1.5] Negative Electrode Side Layered Body

The solid electrolyte slurry was coated on the surface of the negative electrode mixture layer and dried at 100° C. Thereafter, roll pressing was carried out at 2 ton/cm², and the negative electrode side layered body was obtained. The negative electrode side layered body had a negative electrode and a solid electrolyte layer formed on the surface of the negative electrode.

[5.1.6] Assembly

The positive electrode side layered body and the negative electrode side layered body were respectively subjected to unfolding processing. The positive electrode side layered body, the un-pressed solid electrolyte layer (which is the same as the above-described solid electrolyte layer), and the negative electrode side layered body were superposed in that order, and a layered body was obtained. In the layered body, the un-pressed solid electrolyte layer was interposed between the solid electrolyte layer of the positive electrode side layered body and the solid electrolyte layer of the negative electrode side layered body. The layered body was pressed at 130° C. and 2 ton/cm², and a power generating element was obtained. The power generating element had a positive electrode, a solid electrolyte layer formed on the positive electrode, and a negative electrode formed on the solid electrolyte layer. The obtained power generating element was laminate-sealed and restrained at 0.5 MPa. Due thereto, an all-solid-state battery was obtained as a battery for evaluation.

[5.2] Measurement of Initial Resistance

The battery was placed in a thermostat of 25° C. Next, the operation of charging the battery and then discharging the battery (hereinafter called a “charging/discharging cycle”) was carried out two times. In the charging of the battery, constant current charging was carried out until the voltage of the battery reached 2.7 V at a current of ⅓ C rate, and thereafter, constant voltage charging was carried out and was ended at the point in time when the charge current reached an equivalent of 0.01 C. The charging rate was calculated from the design capacity of the battery (a capacity of 2 mAh/cm² per unit surface area of the positive electrode). In the discharging of the battery, constant current discharging was carried out until the voltage of the battery reached 1.5 V at a current of ⅓ C rate, and thereafter, constant voltage discharging was carried out and was ended at the point in time when the discharge current reached an equivalent of 0.01 C.

The battery was placed in a thermostat of 25° C. Charging was carried out until the voltage of the battery reached 2.2 V, and thereafter, the AC impedance of the battery was measured, and discharging was carried out. In the charging of the battery, constant current charging was carried out until the voltage of the battery reached 2.7 V at a current of ⅓ C rate, and thereafter, constant voltage charging was carried out and was ended at the point in time when the charge current reached an equivalent of 0.01 C. The measuring of the impedance characteristic was carried out at an AC amplitude of 10 mV and in a frequency range of 1 MHz to 0.1 Hz. The waveform of the arc-shaped portion expressed in the Nyquist diagram obtained by the AC impedance measurement was circle fit, and a curve was obtained. The difference between the x-axis intercepts at the high frequency side and the low frequency side of the obtained curve was used as the initial resistance. In the discharging of the battery, constant current discharging was carried out until the voltage of the battery reached 1.5 V at a current of ⅓ C rate, and thereafter, constant voltage discharging was carried out and was ended at the point in time when the discharge current reached an equivalent of 0.01 C.

[5.3] Measurement of Resistance Increase Rate

The battery was placed in a thermostat of 60° C., and a cycle test was carried out. In the cycle test, the charging/discharging cycle was repeated 150 times. In the charging of the battery, constant current charging was carried out until the voltage of the battery reached 2.7 V at a current of 5 C rate, and thereafter, constant voltage charging was carried out and was ended at the point in time when the charge current reached an equivalent of ⅓ C. In the discharging of the battery, constant current discharging was carried out until the voltage of the battery reached 1.8 V at a current of 1 C rate.

The battery was placed in a thermostat of 25° C., charging was carried out until the voltage of the battery reached 2.2 V, and thereafter, the AC impedance of the battery was measured. In the charging of the battery, constant current charging was carried out until the voltage of the battery reached 2.7 V at a current of ⅓ C rate, and thereafter, constant voltage charging was carried out and was ended at the point in time when the charge current reached an equivalent of 0.01 C. The measuring of the impedance characteristic was carried out at an AC amplitude of 10 mV and in a frequency range of 1 MHz to 0.1 Hz. The waveform of the arc-shaped portion expressed in the Nyquist diagram obtained by the AC impedance measurement was circle fit, and a curve was obtained. The difference between the x-axis intercepts at the high frequency side and the low frequency side of the obtained curve was used as the resistance after the cycle test. The ratio obtained by dividing the resistance after the cycle test by the initial resistance was used as the resistance increase rate.

TABLE 1

| | positive electrode material | | | | | evaluation | |
|---|---|---|---|---|---|---|---|
| | positive electrode active | sulfide solid | | positive | | | resistance |
| | material complex | electrolyte | binder | electrode active | conductive | initial | increase |
| | (A) | (B) | (C) | material complex | additive | resistance | rate |
| | type | type | type | type | type | Ω | % |
| Example 1 | positive electrode active | sulfide solid | binder | — | — | 5.0 | 0 |
| | material complex | electrolyte | (C1) | | | | |
| | (A1) | (B1) | | | | | |
| | (a1/b1/LTAF(c1)) | | | | | | |
| Comparative | — | sulfide solid | binder | positive electrode active | — | 6.5 | 0 |
| Example 1 | | electrolyte | (C1) | material complex | | | |
| | | (B1) | | (X1) | | | |
| | | | | (a1/LTAF(c1)) | | | |
| Comparative | — | sulfide solid | binder | positive electrode active | conductive | 7.5 | 67 |
| Example 2 | | electrolyte | (C1) | material complex | additive | | |
| | | (B1) | | X1) | (b1) | | |
| | | | | (a1/LTAF(c1)) | | | |
| Comparative | — | sulfide solid | binder | positive electrode active | | 1.8 | 56 |
| Example 3 | | electrolyte | (C1) | material complex | | | |
| | | (B1) | | (X2) | | | |
| | | | | (a1/b1/B1) | | | |

In Table 1, “a1/b1/LTAF(c1)” means the positive electrode active material complex (A1) that has the positive electrode active material (a1), the conductive additive (b1) that covers the entire surface of the positive electrode active material (a1), and LTAF (c1) that covers an entirety of the conductive additive (b1). “LTAF(c1)” means a solid electrolyte formed from Li, Ti, Al and F. “a1/LTAF(c1)” means the positive electrode active material complex (X1) that has the positive electrode active material (a1) and LTAF (c1) that covers the entire surface of the positive electrode active material (a1). “a1/b1/B1” means the positive electrode active material complex (X2) that has the positive electrode active material (a1), the conductive additive (b1) that covers the entire surface of the positive electrode active material (a1), and the sulfide solid electrolyte (B1) that covers the entire conductive additive (b1).

The positive electrode materials of Comparative Example 1 through Comparative Example 3 did not contain the positive electrode active material complex (A). Therefore, in Comparative Example 1, the results of measurement of the initial resistance were greater than in Example 1. In Comparative Example 2, the results of measurement of the initial resistance were greater than in Example 1, and the results of measurement of the resistance increase rate as well were greater than in Example 1. In Comparative Example 3, the results of measurement of the resistance increase rate were greater than in Example 1. Namely, it was understood that the batteries for evaluation of Comparative Example 1 through Comparative Example 3 were not batteries in which the initial resistance was kept low and it was difficult for the resistance to increase even if charging/discharging were repeated. As a result, it could be understood that the positive electrode materials of Comparative Example 1 through Comparative Example 3 could not result in solid-state batteries in which the initial resistance is kept low and it is difficult for the resistance to increase even if charging/discharging are repeated.

The positive electrode material of Example 1 contains the positive electrode active material complex (A1) and the sulfide solid electrolyte (B1). The positive electrode active material complex (A1) contains the positive electrode active material (a1), the conductive additive (b1) that covers the entire surface of the positive electrode active material (a1), and LTAF (c) that covers an entirety of the conductive additive (b1). LTAF (c) contains Li, Ti, A1 and F. Therefore, the initial resistance of Example 1 is 5.0Ω and is smaller than in Comparative Example 1 and Comparative Example 2. Moreover, the resistance increase rate of Example 1 is 0% and is lower than in Comparative Example 2 and Comparative Example 3. Namely, it can be understood that the battery for evaluation of Example 1 is a battery in which the initial resistance is kept low and it is difficult for the resistance to increase even if charging/discharging are repeated. As a result, it can be understood that the positive electrode material of Example 1 can be used to manufacture a solid-state battery in which the initial resistance is kept low and it is difficult for the resistance to increase even if charging/discharging are repeated.

What is claimed is:

1. A positive electrode material comprising a positive electrode active material complex (A) and a sulfide solid electrolyte (B), wherein
the positive electrode active material complex (A) has:
a positive electrode active material (a);
a conductive additive (b) covering at least a portion of a surface of the positive electrode active material (a); and
a solid electrolyte (c) covering at least a portion of the conductive additive (b), and
the solid electrolyte (c) contains Li, Ti, X and F, and
the X is at least one selected from the group consisting of Ca, Mg, Al, Y and Zr.

2. The positive electrode material of claim 1, wherein the X contains Al.

3. The positive electrode material of claim 1, wherein:
the conductive additive (b) covers an entire surface of the positive electrode active material (a), and
the solid electrolyte (c) covers an entirety of the conductive additive (b).

4. A solid-state battery comprising a positive electrode layer, a negative electrode layer, and a solid electrolyte layer disposed between the positive electrode layer and the negative electrode layer,
wherein the positive electrode layer contains the positive electrode material of claim 1.

5. A method of manufacturing a positive electrode material comprising:
covering at least a portion of a surface of a positive electrode active material (a) with a conductive additive (b);
covering at least a portion of the conductive additive (b) with a solid electrolyte (c), and fabricating a positive electrode active material complex (A); and
kneading the positive electrode active material complex (A) and a sulfide solid electrolyte (B),
wherein the solid electrolyte (c) contains Li, Ti, X and F, and
the X is at least one selected from the group consisting of Ca, Mg, Al, Y and Zr.

6. The method of manufacturing a positive electrode material of claim 5, wherein the X contains Al.

7. A method of manufacturing a solid-state battery comprising a step of fabricating a positive electrode material by the method of manufacturing a positive electrode material of claim 5.
